(19) United States
(12) Patent Application Publication
(10) Pub. No.: US 2026/0037713 A1
(43) Pub. Date: Feb. 5, 2026

(54) Combined Machine Learning and Large Language Models

(71) Applicant: Varonis Systems Inc., New York, NY (US)

(72) Inventors: John Eugene Neystadt, Kfar-Saba (IL); Lior Chen, Tel Mond (IL); Amit Osi, Tel Aviv (IL)

(21) Appl. No.: 18/788,970

(22) Filed: Jul. 30, 2024

(51) Int. Cl. G06F 40/103

(52) U.S. Cl. CPC G06F 40/103

(57) ABSTRACT

A computing system is disclosed that utilises a large language to provide scalar indications of characteristics of a document, and a decision-making system to take decisions regarding handling of that document in view of the scalar indications. In one embodiment, one or more computer readable storage media storing program instructions and one or more processors which, in response to executing the program instructions, are configured to: receive a document; extract textual data from the document; request a large language model to provide a scalar indication for each of a plurality of features of the textual data; and utilise a decision system to produce an output based on at least the scalar indications.

### TECHNICAL FIELD

The following disclosure relates to a system for analysing mixed data utilising a combination of machine learning and large language models.

### BACKGROUND

In a range of technical systems there is a requirement to take decisions based on data which comprises a mixture of textual and numeric features. That is, some content is represented in natural language, whereas other data is represented numerically.

Machine learning and large language models are data processing techniques implemented in computing systems which can analyse input data and produce outputs or take decisions based on the input data. Machine learning is an effective technique for analysing numerical data. Following correct training a machine learning system can analyse complex sets of numerical data. However, machine learning is not effective in handling textual, particularly natural language, data. In contrast, Large Language Models (LLM) are effective at handling textual natural language data, but are less effective with structured numerical data and at taking decisions across a large number of features. Neither system is effective with mixed input data.

There is therefore a need for a system which can operate on mixed input data and produce an output, or take decisions, based on both textual and numeric elements of the input data.

### SUMMARY

The invention is defined by the following disclosure and the claims.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding:

FIG. 1 shows a flow chart of a mixed data analysis process, and

FIG. 2 shows an example of a computing device according to the current disclosure.

### DETAILED DESCRIPTION

The present disclosure provides a system which can utilise a combination of machine learning techniques and Large Language Models (LLMs) to analyse mixed data. In a particular example the system is utilised to analyse received email messages to decide whether they are genuine or fraudulent (and hence should be withheld), or should be withheld from users for other reasons. The system can base its analysis on a number of mixed-types of data. By the deployment of interlinked LLM and machine learning systems an improved performance is obtained.

In a simple example, numerical data for an email is a frequency of communication with the sender of an email. The system generates a numerical value for how often the sender sends the recipient an email based on records maintained by the system. The system also analyses the natural language text of the email using an LLM to generate a set of numeric values on a scale for certain features of the language. For example, the number of spelling errors is assessed on a scale of 1-10. A machine learning system trained on these features is then used to assess whether the frequency value and the indication of the number of errors indicates the email should be categorised as genuine or not. For example, an email that scores low on frequency, and high on errors is likely to be fraudulent.

The system thus uses the best features of each type of process in an interlinked structure to decide on what action to take. The LLM is used to analyse and score the language, while the machine learning system is used to analyse numeric values. Without the LLM's analysis and scoring process the machine learning system could not perform its task as well, and vice-versa the LLM could not take a decision across a set of numerical values. This is a very simple example, but in a real system there will be a large number of features which are analysed.

Although the present disclosure will focus on analysis of received emails the same principles can be applied to any type of communication or document. For convenience the input to the system will therefore be referred to as a document, but it will be appreciated this includes any type of input such as emails which may contain data which goes beyond a conventional text-only document, for example the document may contain address information for the sender and recipients.

The system can be divided into two main stages. In a first stage features are extracted from a document using rules and/or an LLM, and then in a second stage a decision system, which is typically based on machine learning techniques, analyses the extracted features. The decision system is configured to output information or decisions based on the document being analysed.

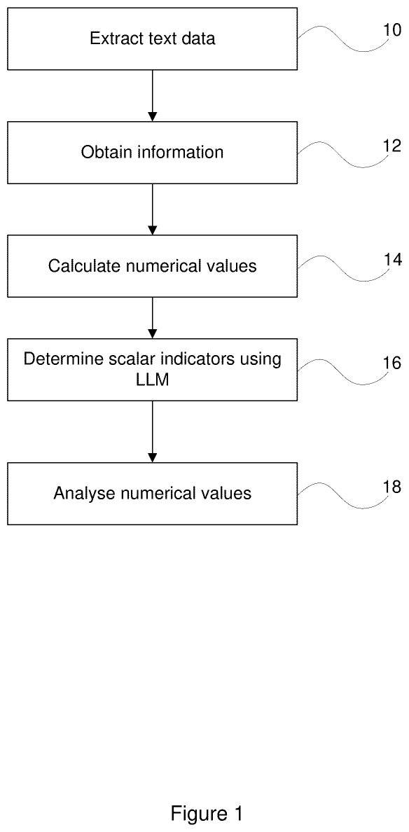

FIG. 1 shows a flowchart of a method according to the current disclosure, which is implemented in a computing system. At step 10 the system extracts textual data from the document. For example in the case of an email that data may be the send and receive addresses, content of the email, and content of any attachments. Other text data may also be present such as times and dates associated with the document, and other meta data of the document.

At step 12 the system obtains information from other parts of the computing system based on identifiers in the document. For example, the organisational database may be searched based on the sender and recipient(s) to identify details of the people associated with the document. For example, their role, level, department, and security clearances may be relevant to how the document is processed. Names and other identifiers (e.g. email addresses, telephone numbers) may also be extracted from the textual data in the document. Any data stored in the computing system may be searched using the identifiers, such as CRM systems and organisational directories.

At step 14 numerical values for certain features are calculated in relation to the document. For example, where the document is an email, the system may calculate how often the sender sends emails to the recipient, or if the email has an attachment how often that type of attachment is sent by the sender. These values may be calculated by the system itself based on a database of information, or by interrogation of other elements of the computer system. As the system analyses documents the appropriate databases are updated such that they are kept up to date with the relevant features and values for analysis of future documents.

At step 16 an LLM is utilised to analyse the natural language content of the document and produce a set of numerical indictors of features of the natural language content. This task uses LLMs' strength in their analysis of natural language, and generates the numerical indicators which can be used in a machine learning system which is strong at analysing and interpreting sets of numeric indicators.

Each numerical indicator is generated by feeding a prompt to an LLM consisting of a request in relation to the required indicator and the text to be analysed. For example, where the feature is urgency the LLM may be passed a prompt to “Provide a numerical indicator on a scale of 1 to 10 of the urgency of the following text <the text of the document>.” As will be appreciated, the relevant content of the document can be passed to the LLM in any known way, for example by concatenating it with the request in the prompt, or passing it separately with a suitable link. The LLM processes the prompt and produces its output in accordance with the language model on which it is built.

The features for which numerical indicators are obtained vary depending on the type of document being analysed. Where the documents are emails, relevant features for which a numerical indicator can be calculated include:—
Urgency of language
Spelling accuracy
Pressure applied to recipient to take certain action
Language which appears disingenuous
Offers which are “too good to be true”,
Attempts to sell products.

High scores on such features may be an indication that the email is not genuine.

The features requested will depend on the type of document being analysed. When analysing a document to determine if it contains sensitive data, features such as the text including health information, personal identification information, financial information, or language indicating any of those types of information are present are more relevant than spelling accuracy. The numerical indicators requested may be tailored to the type of document, or all indicators could be requested for all documents and only the relevant ones utilised by the decision making system.

The result of step 16 is a set of numerical values on a known scale indicating the characteristics of the textual data in relation to the relevant features. Put another way, a score is produced for each of a set of features.

At step 18 the set of numerical values, together with any other extracted numerical values from step 14 and organisational information from step 12 are fed to the decision system to process. That decision system is typically a machine-learning based system, but may also be, or include, a rule-based system. The decision system analyses the numerical values and other data according to its training, or rules, and produces output in accordance with its configuration. The output may be an indication whether the document should be transmitted as requested, or withheld. In the case of incoming emails the email may be withheld and a message delivered to the recipient indicating this has happened. As will be appreciated a variety of decisions and follow-on actions can be performed based on the decision system, such as blocking transmission of the documents, blocking or allowing access, or providing information to users on the analysis performed to allow further human actions.

The output of the decision system may include information on why a certain decision has been reached. For example, the output may be an indication of which numerical features led to a particular decision. If a document has been categorised as a phishing email that may be because it scored highly on spelling errors and text relating to financial information. The output could include all numerical indicators, but it is likely a very large number will be utilised which would not be very meaningful. Furthermore, the LLM could be utilised to generate a natural language explanation of the decision by passing the decision and numerical indicators to the LLM and requesting an explanation. The explanation may also only be provided when a user requests it, or it may only be available to users with certain roles (for example IT supervisors) who are tasked with monitoring user behaviour or compliance with an organisation's rules.

LLMs are generally limited by the number of tokens (representing the input data) which can be processed at a time. As the number of tokens gets too large the LLM becomes less reliable and processing becomes inefficient. If an input document will exceed the allowable number of tokens it can be split into chunks to pass to the LLM in stages. For example, the document may be split into pages or paragraphs which are each fed to the LLM in turn with appropriate prompts to generate the requested numerical indicators. The numerical indicators for each chunk can then be analysed as most appropriate for the type of data. In some circumstances taking an average of the values from each chunk may be most appropriate (for example when looking at spelling quality), or in other circumstances taking the maximum value may be most appropriate (for example when deciding if medical data is present). Alternatively the prompt to the LLM may include a request to consider previous values (which will be provided with the prompt as LLMs do not store previous output) when analysing subsequent chunks.

Further techniques may be utilised to improve the accuracy of the numeral indicators generated at step 16 of the method discussed above. In a first example, an indicator for the same feature may be requested in different ways. For example, in relation to the example above (“Provide a numerical indicator on a scale of 1 to 10 of the urgency of the following text <the text of the document>.”), the system may also ask the LLM “Rate how urgent the senders language is in the following text, on a scale of 1 to 10”, and “On a scale of 1 to 10, how much of a rush does the sender of the following text seem to be in.” The system may then use the average, highest, or lowest value returned by the LLM. The output of an LLM can be sensitive to the words used in the question in relation to the words used in the text it is responding based on, such that results could be dependent on the question rather than the actual characteristics of the text. The use of multiple questions is intended to remove such variability. Which output value is used may be dependent on the type of question. For example, for urgency the average value may be most appropriate, but for whether an email contains important financial information the maximum value may be utilised.

In another approach to generating the numerical indicators, the LLM may be provided with deliberately wrong indicators and asked to determine if they are correct. For example, for a characteristic with a low score for urgency, the LLM could be asked “Is a numerical indicator of 10 on a scale of 1-10 correct for the urgency of the following text . . . ”. If the LLM disagrees with the value it is a good indicator that the low score is correct.

In a further example in relation to determining whether an email should be categorised as spam the LLM may be asked “An analyst has categorised this email as not spam, on a scale of 1-10 do you agree with the analyst's categorisation”. If the provided email does appear to be spam the LLM would be expected to return a low score, contradicting the analyst's false view that was provided to the LLM.

Where the decision system includes a machine learning element, that element may be trained using known techniques. For example, a training set of documents may be prepared by tagging them with the desired output of the decision system. The documents are passed through the extraction steps of FIG. 1 and the resulting numerical indicators passed to the machine learning model with the tags such that the model learns the desired behaviours.

Where the decision system includes a rule-based approach, the thresholds used by the rules are defined during the configuration of the system such that the decision system can compare the numerical indicators to the threshold to take a decision regarding a document.

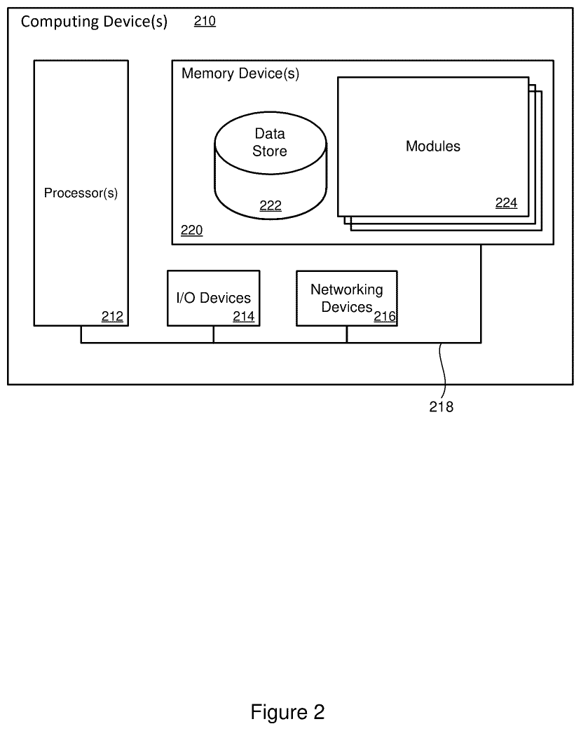

FIG. 2 illustrates a computing device 210 on which modules of this technology may execute. A computing device 210 is illustrated on which a high level example of the technology may be executed. The computing device 210 may include one or more processors 212 that are in communication with memory devices 220. The computing device 210 may include a local communication interface 218 for the components in the computing device. For example, the local communication interface 218 may be a local data bus and/or any related address or control busses as may be desired.

The memory device 220 may contain modules 224 that are executable by the processor(s) 212 and data for the modules 224. In one aspect, the memory device 220 may include a checkpoint manager, a migration management module, and other modules. In another aspect, the memory device 220 may include a network connect module and other modules. The modules 224 may execute the functions described earlier. A data store 222 may also be located in the memory device 220 for storing data related to the modules 224 and other applications along with an operating system that is executable by the processor(s) 212.

Other applications may also be stored in the memory device 220 and may be executable by the processor(s) 212. Components or modules discussed in this description that may be implemented in the form of software using high-level programming languages that are compiled, interpreted or executed using a hybrid of the methods.

The computing device may also have access to I/O (input/output) devices 214 that are usable by the computing devices. Networking devices 218 and similar communication devices may be included in the computing device. The networking devices 218 may be wired or wireless networking devices that connect to the internet, a LAN, WAN, or other computing network.

The components or modules that are shown as being stored in the memory device 220 may be executed by the processor(s) 212. The term “executable” may mean a program file that is in a form that may be executed by a processor 212. For example, a program in a higher level language may be compiled into machine code in a format that may be loaded into a random access portion of the memory device 220 and executed by the processor 212, or source code may be loaded by another executable program and interpreted to generate instructions in a random access portion of the memory to be executed by a processor. The executable program may be stored in any portion or component of the memory device 220. For example, the memory device 220 may be random access memory (RAM), read only memory (ROM), flash memory, a solid state drive, memory card, a hard drive, optical disk, floppy disk, magnetic tape, or any other memory components.

The processor 212 may represent multiple processors and the memory device 220 may represent multiple memory units that operate in parallel to the processing circuits. This may provide parallel processing channels for the processes and data in the system. The local interface 218 may be used as a network to facilitate communication between any of the multiple processors and multiple memories. The local interface 218 may use additional systems designed for coordinating communication such as load balancing, bulk data transfer and similar systems.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term “comprising” or “including” does not exclude the presence of other elements. Similarly the use of the singular does not exclude the plural and vice-versa.

The term “computer” or “computing device” is used herein to refer to any computing device which can execute software and provide input and output to and from a user. For example, the term computer explicitly includes desktop computers, laptops, terminals, mobile devices, and tablets, as well as any similar or comparable devices. There is no intended difference between the terms computer, computing system or computing device, all of which fall within the same definition of computer.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable storage media or, more generally, a computer program product. The computer readable storage media, as the term is used herein, is not to be construed as storage in the form of transitory signals per se, such as radio waves or other freely propagating electromagnetic waves. The one or more computer readable storage media could be, for example, an electronic, magnetic, optical, electromagnetic, infrared, or semiconductor system, or a propagation medium for data transmission, for example for downloading the code over the Internet. Alternatively, the one or more computer readable storage media could take the form of one or more physical computer readable media such as semiconductor or solid state memory, magnetic tape, a removable computer diskette, a random access memory (RAM), a read-only memory (ROM), a rigid magnetic disc, and an optical disk.

The following numbered clauses describe aspects of the disclosure:—
1. A computer system for document analysis, comprising:
   one or more computer readable storage media storing program instructions and one or more processors which, in response to executing the program instructions, are configured to: receive a document; extract textual data from the document; requesting a large language model to provide a scalar indication for each of a plurality of features of the textual data; and utilise a decision system to produce an output based on at least the scalar indications.
2. A computer system according to clause 1, wherein the decision system comprises a machine learning model.
3. A computer system according to clause 1, wherein the decision system comprises a rules-based system.
4. A computer system according to any of clauses 1 to 3, wherein the one or more processors are further configured to obtain information based on at least one identifier associated with the document.
5. A computer system according to clause 4, wherein the at least one identifier is an indication of a person's identity who is associated with the document and the information is obtained from an organisational database.
6. A computer system according to claim 5, wherein the obtained information is an indication of how often there are communications with the identified person.
7. A computer system according to any preceding clause, wherein the document is an email and the textual data comprises the text body of the email.
8. A computer system according to any preceding clause, wherein at least one of the scalar indications is an indication of the quantity of content relating to a feature.
9. A computer system according to any preceding clause, wherein at least one of the scalar indications is an indication of the strength of language in relation to a feature.
10. A computer system according to any preceding clause, wherein the at least one feature of the textual data include at least one of the urgency of language used, spelling accuracy, pressure applied to recipient to take certain action, language which appears disingenuous, offers which are “too good to be true”, and attempts to sell products.
11. A computer system according to any preceding clause, wherein the step of requesting a scalar indication comprises requesting a plurality of scalar indications from the large language model for at least one of the features, wherein each of the plurality of scalar indications are requested using a different form of the question.
12. A computer system according to clause 11, wherein the decision system utilises the average, minimum or maximum of the plurality of scalar indications for a feature.
13. A computer system according to any preceding clause, wherein the step of requesting a scalar indication comprises requesting the large language model to verify a deliberately false scalar indication to verify confidence in a scalar indication provided by the large language model.
14. A computer-implemented method, comprising the steps of at a computer system comprising one or more computer readable storage media and one or more processors, receiving a document; extracting textual data from the document; requesting a large language model to provide a scalar indication for each of a plurality of features of the textual data; and utilising a decision system to produce an output based on at least the scalar indications.
15. A computer system according to clause 14, wherein the decision system comprises a machine learning model.
16. A computer system according to clause 14, wherein the decision system comprises a rules-based system.
17. A computer-implemented method according to any of clauses 14 to 16, further comprising the step of obtaining information based on at least one identifier associated with the document.
18. A computer-implemented method according to any of clauses 14 to 17, wherein the at least one identifier is an indication of a person's identity who is associated with the document and the information is obtained from an organisational database.
19. A computer system according to clause 18, wherein the obtained information is an indication of how often there are communications with the identified person.
20. A computer-implemented method according to any of clauses 14 to 19, wherein the document is an email and the textual data comprises the text body of the email.
21. A computer system according to any of clauses 14 to 20, wherein at least one of the scalar indications is an indication of the quantity of content relating to a feature.
22. A computer system according to any of clauses 14 to 21, wherein at least one of the scalar indications is an indication of the strength of language in relation to a feature.
23. A computer-implemented method according to any of clauses 14 to 22, wherein the at least one feature of the textual data includes at least one of the urgency of language used, spelling accuracy, pressure applied to recipient to take certain action, language which appears disingenuous, offers which are “too good to be true”, and attempts to sell products.
24. A computer-implemented method according to any of clauses 14 to 23, wherein the step of requesting a scalar indication comprises requesting a plurality of scalar indications from the large language model for at least one of the features, wherein each of the plurality of scalar indications are requested using a different form of the question.
25. A computer-implemented method according to clause 24, wherein the decision system utilises the average, minimum or maximum of the plurality of scalar indications for a feature.
26. A computer-implemented method according to any of clauses 14 to 25, wherein the step of requesting a scalar indication comprises requesting the large language model to verify a deliberately false scalar indication to verify confidence in a scalar indication provided by the large language model.

What is claimed is:

1. A computer system for document analysis, comprising:
one or more computer readable storage media storing program instructions and one or more processors which, in response to executing the program instructions, are configured to:
receive a document;
extract textual data from the document;
requesting a large language model to provide a scalar indication for each of a plurality of features of the textual data; and
utilise a decision system to produce an output based on at least the scalar indications.

2. A computer system according to claim 1, wherein the decision system comprises a machine learning model.

3. A computer system according to claim 1, wherein the decision system comprises a rules-based system.

4. A computer system according to claim 1, wherein the one or more processors are further configured to obtain information based on at least one identifier associated with the document.

5. A computer system according to claim 4, wherein the at least one identifier is an indication of a person's identity who is associated with the document and the information is obtained from an organisational database.

6. A computer system according to claim 5, wherein the obtained information is an indication of how often there are communications with the identified person.

7. A computer system according to claim 1, wherein the document is an email and the textual data comprises the text body of the email.

8. A computer system according to claim 1, wherein at least one of the scalar indications is an indication of the quantity of content relating to a feature.

9. A computer system according to claim 1, wherein at least one of the scalar indications is an indication of the strength of language in relation to a feature.

10. A computer system according to claim 1, wherein the at least one feature of the textual data include at least one of the urgency of language used, spelling accuracy, pressure applied to recipient to take certain action, language which appears disingenuous, offers which are “too good to be true”, and attempts to sell products.

11. A computer system according to claim 1, wherein the step of requesting a scalar indication comprises requesting a plurality of scalar indications from the large language model for at least one of the features, wherein each of the plurality of scalar indications are requested using a different form of the question.

12. A computer system according to claim 11, wherein the decision system utilises the average, minimum or maximum of the plurality of scalar indications for a feature.

13. A computer system according to claim 1, wherein the step of requesting a scalar indication comprises requesting the large language model to verify a deliberately false scalar indication to verify confidence in a scalar indication provided by the large language model.

14. A computer-implemented method, comprising the steps of
at a computer system comprising one or more computer readable storage media and one or more processors:—
receiving a document;
extracting textual data from the document;
requesting a large language model to provide a scalar indication for each of a plurality of features of the textual data; and
utilising a decision system to produce an output based on at least the scalar indications.

15. A computer-implemented method according to claim 14, further comprising the step of obtaining information based on at least one identifier associated with the document.

16. A computer-implemented method according to claim 14, wherein the at least one identifier is an indication of a person's identity who is associated with the document and the information is obtained from an organisational database.

17. A computer-implemented method according to claim 14, wherein the document is an email and the textual data comprises the text body of the email.

18. A computer-implemented method according to claim 14, wherein the at least one feature of the textual data include at least one of the urgency of language used, spelling accuracy, pressure applied to recipient to take certain action, language which appears disingenuous, offers which are “too good to be true”, and attempts to sell products.

19. A computer-implemented method according to claim 14, wherein the step of requesting a scalar indication comprises requesting a plurality of scalar indications from the large language model for at least one of the features, wherein each of the plurality of scalar indications are requested using a different form of the question.

20. A computer-implemented method according to claim 14, wherein the step of requesting a scalar indication comprises requesting the large language model to verify a deliberately false scalar indication to verify confidence in a scalar indication provided by the large language model.
